(19) United States
(12) Patent Application Publication
(10) Pub. No.: US 2013/0213498 A1
(43) Pub. Date: Aug. 22, 2013

(54) VEHICLE BRAKE FLUID PRESSURE CONTROL APPARATUS

(71) Applicant: Nissin Kogyo Co., Ltd., (US)

(72) Inventors: Masatoshi IYATANI, Nagano (JP); Naoki MASUDA, Nagano (JP)

(73) Assignee: NISSIN KOGYO CO., LTD., Nagano (JP)

(21) Appl. No.: 13/772,696

(22) Filed: Feb. 21, 2013

(30) Foreign Application Priority Data
Feb. 22, 2012 (JP) 2012-036020

(51) Int. Cl. F16K 15/02

(52) U.S. Cl. CPC F16K 15/025
USPC 137/535

(57) ABSTRACT

One embodiment provides a vehicle brake fluid pressure control apparatus, including: a base body having a reservoir storing hole; a reservoir piston stored within the reservoir storing hole, the reservoir piston and the reservoir storing hole defining a reservoir chamber therebetween; a reservoir spring which urges the reservoir piston at one end thereof in a direction to reduce a capacity of the reservoir chamber; a first guide member disposed to contact with the one end of the reservoir spring; and a second guide member disposed to contact with the other end of the reservoir spring. The first guide member and the second guide member are disposed across the reservoir spring. The first guide member includes a first engaging portion. The second guide member includes a second engaging portion, the second engaging portion being engageable with the first engaging portion from inside or outside.

### CROSS-REFERENCE TO RELATED APPLICATION(S)

This application claims priority/priorities from Japanese Patent Application No. 2012-036020 filed on Feb. 22, 2012, the entire contents of which are incorporated herein by reference.

### FIELD

The present invention relates to a vehicle brake fluid pressure control apparatus for controlling brake pressure.

### BACKGROUND

For example, JP-H06-008810-A discloses a reservoir including a valve body provided in a flow passage communicating with a reservoir chamber, a reservoir piston having a projection, and a reservoir spring for urging the reservoir piston.

In JP-H06-008810-A, when the valve body is pressed by the projection of the reservoir piston and is thus separated from its seat, the flow passage is opened. In this case, since the initial position of the reservoir piston is set according to the height-direction dimension of the reservoir spring, it is necessary to restrict variations in the height-direction dimension of the reservoir spring (the elongation of the reservoir spring in the height direction).

In view of the above, JP-2008-007080-A discloses a structure in which one member to be secured to one end of a reservoir spring and the other member to be secured to the other end of the reservoir spring are fastened together using a bolt and a nut to thereby restrict the elongation of the reservoir spring.

However, in JP-2008-007080-A, the fastening operation by the bolt and the nut is complicated and the number of assembling steps increases by an amount corresponding to the fastening operation.

### SUMMARY

An aspect of the present invention provides a vehicle brake fluid pressure control apparatus, including: a base body having a reservoir storing hole; a reservoir piston stored within the reservoir storing hole, the reservoir piston and the reservoir storing hole defining a reservoir chamber therebetween; a reservoir spring which urges the reservoir piston at one end thereof in a direction to reduce a capacity of the reservoir chamber; a first guide member disposed to contact with the one end of the reservoir spring; and a second guide member disposed to contact with the other end of the reservoir spring, wherein the first guide member and the second guide member are disposed across the reservoir spring, wherein the first guide member includes a first engaging portion, and wherein the second guide member includes a second engaging portion, the second engaging portion being engageable with the first engaging portion from inside or outside.

Since the first and second guide members are connected together through the engagement between the first and second engaging portions to thereby restrict the elongation (length) of the reservoir spring, there is eliminated the need for use of other members (for example, the bolt and the nut in JP-H06-008810-A), which can reduce the number of parts and thus the manufacturing cost of the brake control apparatus.

There may also be provided the apparatus, wherein the first engaging portion includes a first pawl, wherein the second engaging portion includes a second pawl, and wherein the first pawl and the second pawl are engaged with each other through a snap-fit. According to the above configuration, the first and second pawls can be engaged with each other easily.

There may also be provided the apparatus, further comprising: a plug disposed to seal the reservoir storing hole, the plug being disposed opposite to the reservoir piston across the reservoir spring to thereby support a reacting force of the reservoir spring, and wherein the second guide member is fixed to the plug. According to the above configuration, since the second guide member can be positioned, the first guide member, the second guide member and the reservoir spring are caused to stay at their respective given positions, thereby preventing these members from moving within the reservoir storing hole unnecessarily.

There may also be provided the apparatus, further comprising: a plug disposed to seal the reservoir storing hole, the plug being disposed opposite to the reservoir piston across the reservoir spring to thereby support a reacting force of the reservoir spring, and wherein the second guide member is formed integrally with the plug. According to the above configuration, the first guide member and the reservoir spring engaged with the second guide member can be caused to stay at their respective given positions and also the number of parts and thus the manufacturing cost of the brake control apparatus can be reduce.

There may also be provided the apparatus, wherein the first guide member is made of metal material. According to the above configuration, since the first guide member is enhanced in rigidity and strength and is thereby hard to deform, the restoring force of the reservoir spring can be accepted properly.

There may also be provided the apparatus, wherein one of the first and second pawls is formed as multiple pawls circumferentially arranged at regular intervals, and wherein the other of the first and second pawls is formed to have a continuous circular band shape. According to the above configuration, for example, in the case that the first pawl has the circular band shape, even when the second guide member rotates about its own axis, its engagement with the first guide member can be maintained. This also eliminates the setting of the assembling direction of the first and second guide members in the peripheral direction, thereby enhancing the assembling efficiency of the brake control apparatus.

There may also be provided the apparatus, wherein the first guide member is disposed to contact the reservoir piston. There may also be provided the apparatus, wherein the first guide member is formed integrally with the reservoir piston.

The invention can provide a vehicle brake fluid pressure control apparatus which, by restricting the elongation of the reservoir spring with a simple structure, can simplify its assembling operation and restrict the number of assembling steps.

### BRIEF DESCRIPTION OF DRAWINGS

FIG. 1 is a schematic structure view of a vehicle brake system incorporating therein a vehicle brake fluid pressure control apparatus according of an embodiment.

FIG. 2 is a schematic structure longitudinal section view of a reservoir, a suction valve and the like.

FIG. 3 is a longitudinal section view, with the A portion of FIG. 2 enlarged.

FIG. 4 is a longitudinal section view taken along the IV-IV line of FIG. 2.

FIG. 5 is a perspective view of a guide mechanism.

FIG. 6A is a side view of the guide mechanism, and FIG. 6B is a longitudinal section view taken along the axial direction of the guide mechanism.

FIG. 7A is a perspective view of a first guide member, and FIG. 7B is a longitudinal section view taken along the axial direction of the first guide member.

FIG. 8A is a perspective view of a second guide member, FIG. 8B is a plan view of the second guide member, and FIG. 8C is a side view of the second guide member.

FIG. 9 is a perspective view of a push plate.

FIG. 10A is a plan view of the push plate, FIG. 10B is a front view of the push plate, and FIG. 10C is a left side view of the push plate.

FIG. 11A is a perspective view of a plate spring member, FIG. 11B is a plan view of the plate spring member, and FIG. 11C is a side view of the plate spring member.

FIG. 12 is an operation explanatory view of the principle of leverage in the plate spring member.

FIG. 13 is a typical view of the operation of the reservoir, an intermediate valve and the suction valve in a normal operation.

FIG. 14 is a typical view of the operation of the reservoir, the intermediate valve and the suction valve in an ABS operation.

FIG. 15A is a typical view, showing a state before a pressure self-raising operation, and FIG. 15B is a typical view, showing the state of the pressure self-raising operation.

FIG. 16A is a typical view, showing a state where a pump suction chamber and a reservoir chamber are in a negative pressure state after the end of brake control, and FIG. 16B is a typical view, showing a state where the suction valve is opened and the negative pressure state is thereby removed.

FIG. 17A is a typical view, showing a state where brake fluid remains within the reservoir chamber after the end of the brake control, and FIG. 17B is a typical view, showing a state where the suction valve is opened and the remaining brake fluid is thereby returned toward the master cylinder.

FIG. 18 is a partially cut-out perspective view of a guide mechanism according to another embodiment.

### DETAILED DESCRIPTION

Embodiments will be described with reference to the drawings.

A vehicle brake fluid pressure control apparatus (brake control apparatus) according to an embodiment is suitable for use in a vehicle such as a motor cycle, a motor tricycle, an all terrain vehicle (ATV) and a motor four-wheel vehicle, and is used to control properly brake force (brake fluid pressure) to be applied to the wheels of the vehicle. In the following example, a case where the brake control apparatus is applied to a motor four-wheel vehicle (not shown) will be described. However, this does not intend to limit a vehicle on which the brake control apparatus is to be mounted.

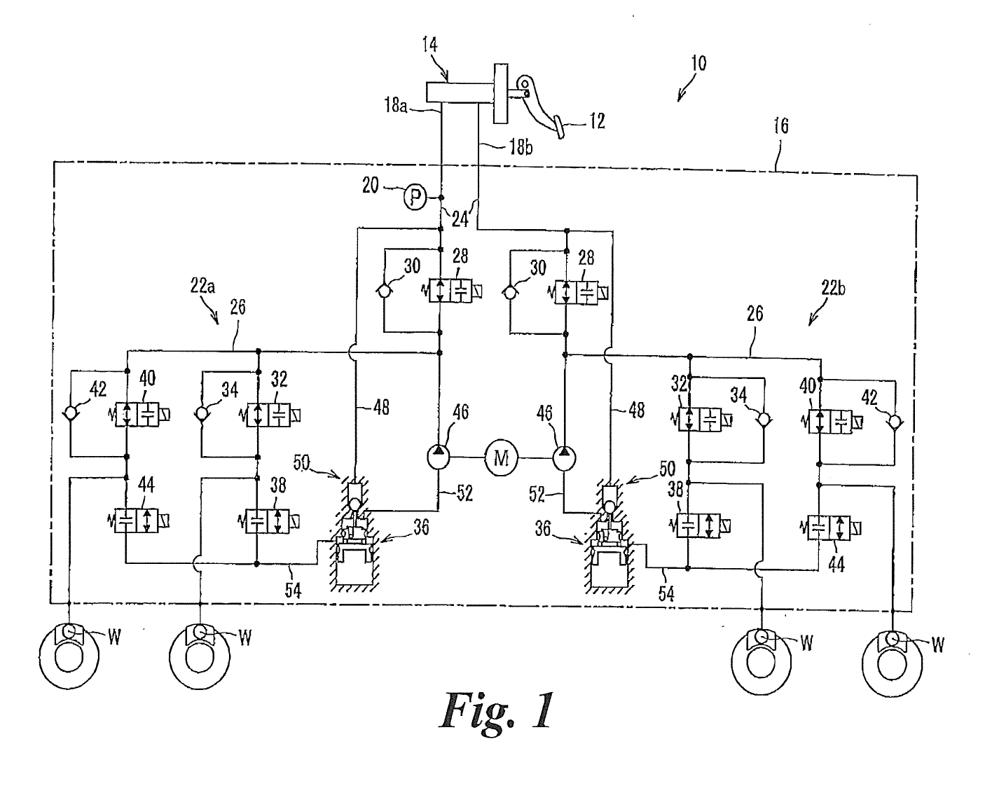

FIG. 1 is a schematic structure view of a vehicle brake system in which the brake control apparatus is incorporated.

This vehicle brake system 10 includes a tandem-type master cylinder 14 for generating fluid pressure by an operator operating a brake pedal (a brake operation member), and a brake control apparatus 16 for controlling brake fluid pressure (master cylinder pressure) introduced from the two output ports of the master cylinder 14 to output it to the respective wheel cylinders W. The output port of the master cylinder 14 is connected to the brake control apparatus 16 through a first fluid pressure passage 18a and a second fluid pressure passage 18b.

Within the brake control apparatus 16, the first fluid pressure passage 18a is connected to a first brake system 22a, and the second fluid pressure passage 18b is connected to a second brake system 22b. The first brake system 22a and the second brake system 22b respectively have the same structure. Thus, the corresponding elements of the two systems are given the same designations, and description is given mainly of the first brake system 22a, while emitting the description of the second brake system 22b.

The first brake system 22a includes a first common fluid pressure passage 24 and a second common fluid pressure passage 26 which are used in common with respect to the respective wheel cylinders W. A pressure sensor 20 for detecting the output pressure of the master cylinder 14 is disposed on the first common fluid pressure passage 24 of the first brake system 22a. A regulator valve 28 constituted of a normally-open-type solenoid valve and a first check valve 30 allowing only the flow of the brake fluid pressure toward the respective wheel cylinders W are parallel interposed between the first common fluid pressure passage 24 and the second common fluid pressure passage 26.

Between the second common fluid pressure passage 26 and the wheel cylinders W disposed on one side, there are parallel interposed, through the respective branch passages, a first in valve 32 constituted of a normally-open-type solenoid valve, and a second check valve 34 allowing only the flow of the brake fluid pressure from the one-side wheel cylinders W to the second common fluid pressure passage 26. Also, a first out valve 38 constituted of a normally-closed-type solenoid valve is interposed between the one-side wheel cylinders W and a reservoir 36 (which is discussed later) through a branch passage.

Between the second common fluid pressure passage 26 and the other-side wheel cylinders W, there are parallel interposed, through the respective branch passages, a second in valve 40 constituted of a normally-open-type solenoid valve 40 and a third check valve 42 allowing only the flow of the brake fluid pressure from the other-side wheel cylinders W to the second common fluid pressure passage 26. Also, a second out valve 44 constituted of a normally-closed-type solenoid valve is interposed through a branch passage between the other-side wheel cylinders W and a reservoir 36 (which is discussed later)

This brake control apparatus 16 further includes a motor M disposed downstream of the regular valves 28 for driving pumps 46 respectively for supplying the brake fluid toward the second common fluid pressure passages 26, and suction valves 50 respectively provided in the fluid pressure passages 40 branched from the first common fluid pressure passages 24.

Each reservoir 36 communicates with the suction valve 50 when an opening/closing valve 104 (which is discussed later) is opened, communicates with the suction side of the pump 46 through a fluid pressure passage (suction passage) 52, and further communicates with the first out valve 38 and the second out valves 44 through the other fluid pressure passage (suction passage) 54.

Nest, the operation of the vehicle brake system 10 will be described.

When the brake pedal 12 is operated, the brake pressure within the master cylinder 14 is pressurized to generate brake pressure (master cylinder pressure). This master cylinder pressure is transmitted to the respective wheel cylinders W through the normally-open-type first in valve 32 or the normally-open-type second in valve 40, whereby the respective wheel cylinders W are operated and thus desired brake force is applied to the respective wheels.

For example, when ABS control is started to reduce the brake fluid pressure within the wheel cylinders W, according to a control signal from control means (not shown), the first in valve 32 is switched to its closed state and the normally-closed-type first out valve 38 is switched to its open state. Also, according to a control signal from control means (not shown), the second in valve 40 is switched to its closed state and the normally-closed-type second out valve 44 is switched to its open state. As a result, the brake fluid pressure within the wheel cylinders W is introduced to the reservoir 36 through the first out valve 38 and/or the second out valve 44, thereby reducing the brake fluid pressure within the wheel cylinders W.

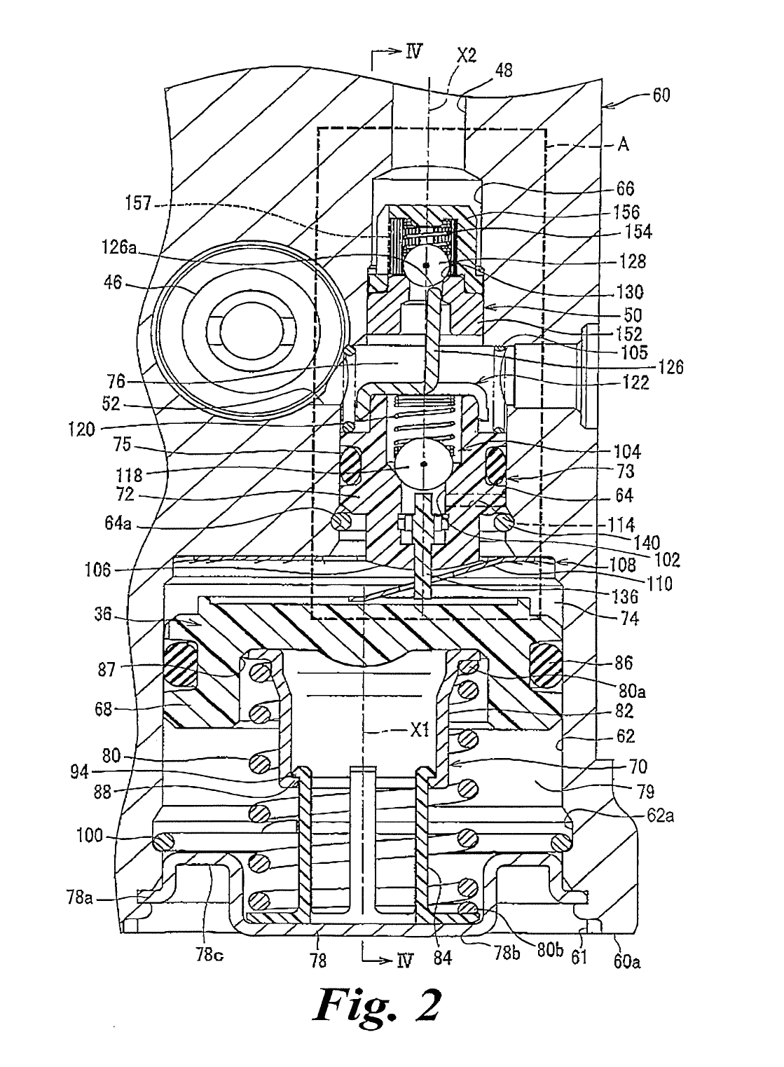

Further, for example, in a pressure self-raising operation to raise wheel cylinder pressure in order to apply brake force to the wheels automatically even when an operator does not carry out a braking operation, such as the vehicle stability assistance and the traction control, the pump 46 is driven by a control signal from control means (not shown) to thereby switch the reservoir 36 to a negative pressure state. A pressure difference due to this negative pressure state is used to shift an intermediate piston 72 to be discussed later (see FIG. 2) and thus open the suction valve 50, thereby allowing the fluid pressure passages 48 and 52 to communicate with each other. Therefore, the brake fluid flowed from the master cylinder 14 is supplied by the pump 46 to the respective wheel cylinders W through the first in valve 32 and/or the second in valve 40, thereby raising the respective wheel cylinder pressures. As a result, even without brake operation by the operator, the brake force is automatically applied to the wheels. To open the suction valve 50 using the pressure difference caused by the negative pressure state will be described specifically in the column <Pressure Self-Raising Operation> that is discussed later.

Next, the concrete structures of the reservoir 36, suction valve 50 and the like are described below specifically with reference to FIGS. 2 to 12.

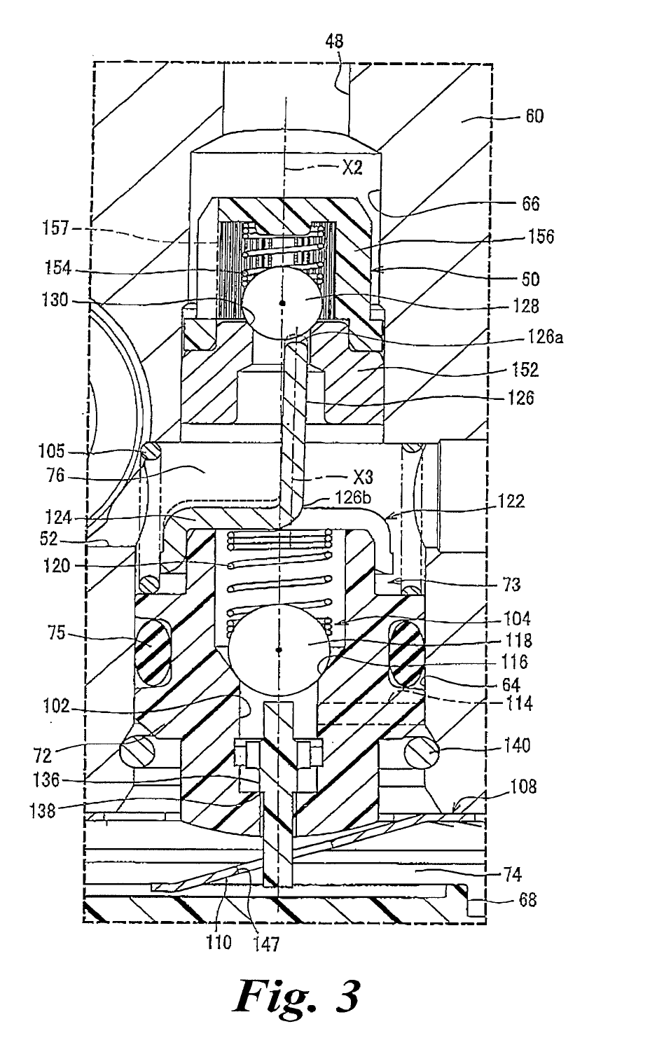

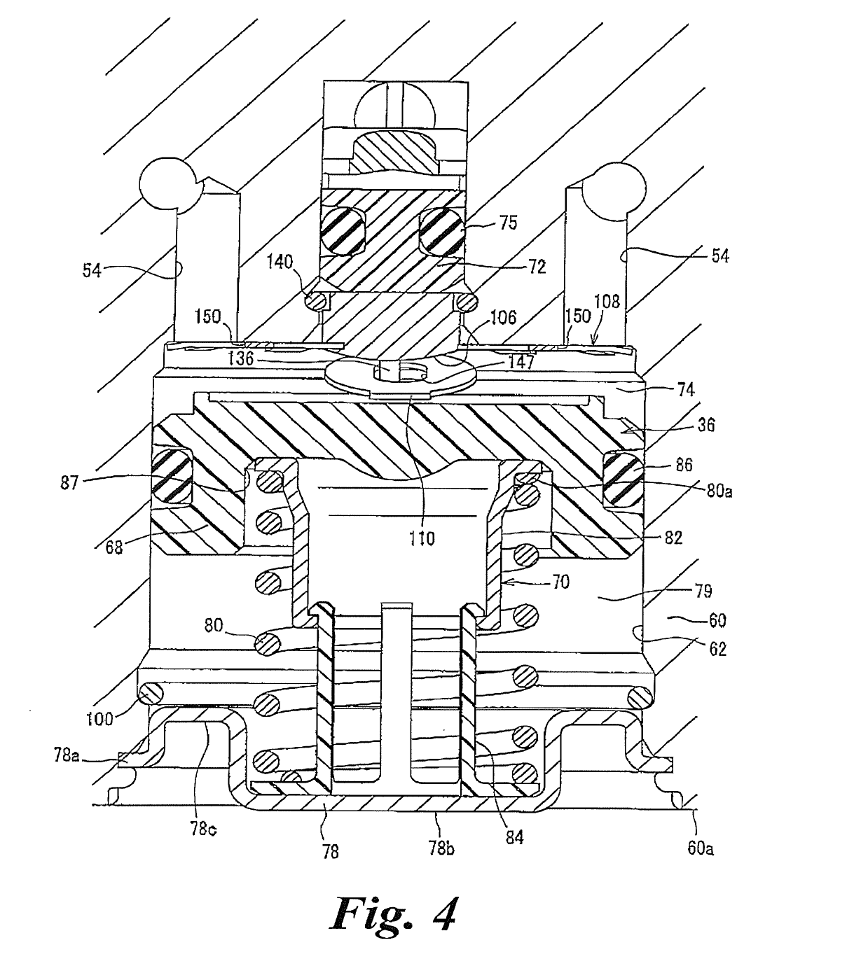

FIG. 2 is a schematic structure longitudinal section of the reservoir, the suction valve and the like, FIG. 3 is an enlarged longitudinal section view of the A portion of FIG. 2, and FIG. 4 is a longitudinal section view taken along the IV-IV line of FIG. 2.

A base body 60, which is constituted of a metal-made block body having a substantially rectangular-shaped section, includes, from its one end surface 60a having a substantially circular opening 61 toward the other end surface (the opposite surface), a reservoir storing hole 62 having a relatively large diameter, an intermediate valve storing hole 64 having a smaller diameter than the reservoir storing hole 62 and a suction valve storing hole 66 having a smaller diameter than the intermediate valve storing hole 64, while these holes are formed continuously in this order.

The reservoir storing hole 62 has a bottomed cylindrical shape. A reservoir 36 and a guide mechanism 70 are disposed within this hole 62. The reservoir 36 includes a reservoir piston 68 movable along the reservoir storing hole 62. The guide mechanism 70 restricts the elongation of a reservoir spring 80. An intermediate valve 73 is disposed within the intermediate valve storing hole 64. This intermediate valve 73 has an intermediate piston 72 capable of opening the suction valve 50 existing upwardly thereof. In the suction valve storing hole 66, there is disposed the normally-closed type suction valve 50 which, when opened, allows the reservoir 36 and the master cylinder 14 to communicate with each other.

A reservoir chamber 74 is formed between the reservoir piston 68 and the intermediate piston 72. This reservoir chamber 74 is communicatingly connected through fluid pressure chambers 54 (see FIG. 4) to the first out valve 38 and the second out valve 44. Also, a pump suction chamber 76 is formed between the intermediate piston 72 and the suction valve 50. This pump suction chamber 76 is communicatingly connected through a fluid pressure passage 52 (see FIGS. 2 and 3) to the suction side of a pump 46.

The reservoir 36 has a substantially disk-shaped plug 78 for sealing (closing) the reservoir storing hole 62. This plug 78 includes an annular flange portion 78a contactable with the opening 61 of the reservoir storing hole 62, a central projecting portion 78b formed flush with one end surface 60a of the base body 60, and an annular recessed portion 78c formed between the central projecting portion 78b and the annular flange portion 78a. In this case, to fix the plug 78, its side wall forming the annular recessed portion 78c may be pressed into the reservoir storing hole 62 and the open ends of the opening 61 may be calked so as to hold the annular flange portion 78a between them. Between the reservoir piston 68 and the plug 78, there is formed an atmospheric pressure chamber 79 which communicates with the atmosphere through a breathing passage (not shown).

Also, between the reservoir piston 68 and the plug 78, there is interposed the reservoir spring 80 for urging the reservoir piston 68 in a direction to reduce the capacity of the reservoir chamber 74. This reservoir spring 80 is constituted of a coil spring, while its one end (upper end) 80a is engageable with the first guide member 82 of the guide mechanism 70 (to be described later) and the other end (lower end) 80b is engageable with a second guide member 84. The plug 78 is opposite to the reservoir piston 68 across the reservoir spring 80 and has a function to support the reaction force of the reservoir spring 80.

The reservoir piston 68 is constituted of a bottomed cylindrical resin member and a seal member 86 constituted of an O ring is mounted onto an annular groove formed in the outer peripheral surface of the piston 68. The reservoir piston 68 includes an annular recessed portion 87 formed in the bottom surface central portion thereof. The first guide member 82 of the guide mechanism 70 (which is discussed later) can be contacted with the ceiling surface of the inside of the annular recessed portion 87.

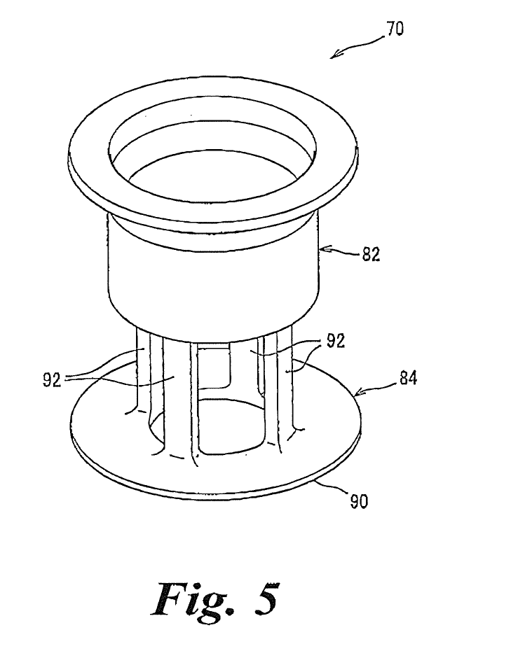

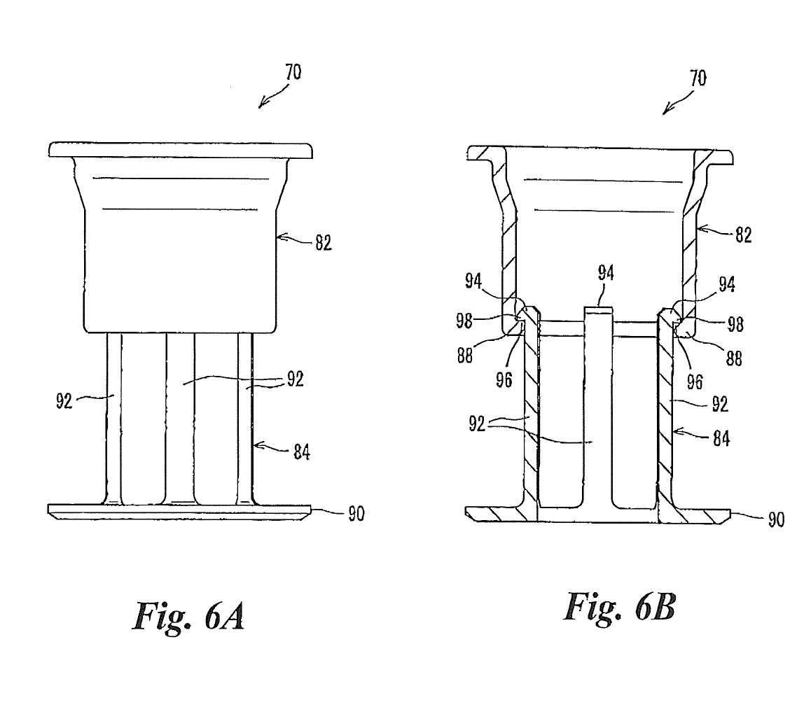

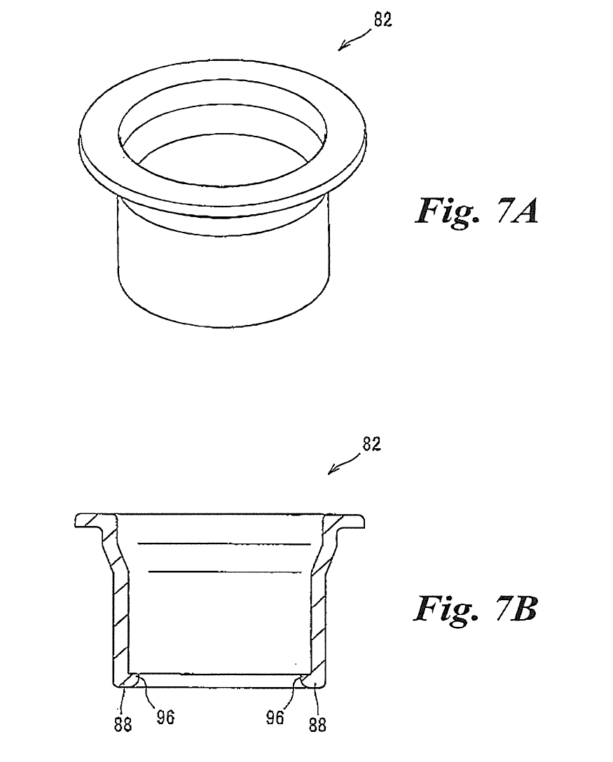

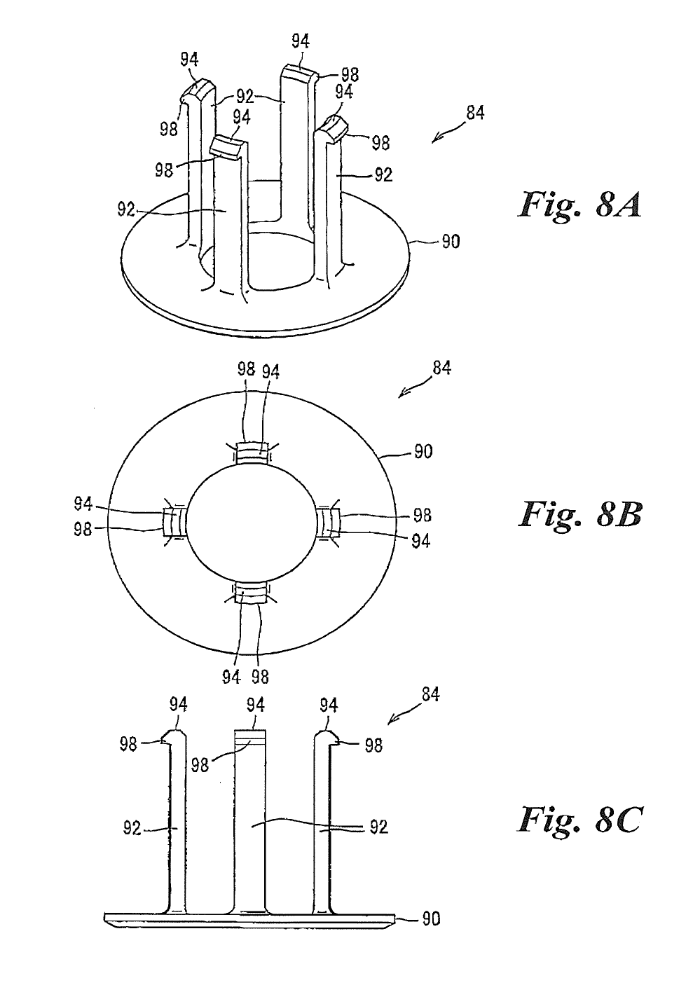

FIG. 5 is a perspective view of the guide mechanism, FIG. 6A is a side view of the guide mechanism, FIG. 6B is a longitudinal section view taken along the axial direction of the guide mechanism, FIG. 7A is a perspective view of the first guide member, FIG. 7B is a longitudinal section view taken along the axial direction of the first guide member, FIG. 8A is a perspective view of the second guide member, FIG. 8B is a plan view of the second guide member, and FIG. 8C is a side view of the second guide member.

The guide mechanism 70 includes the first guide member 82 contactable with one end 80a of the reservoir spring 80 disposed on the side of the reservoir piston 68, and the second guide member 84 contactable with the other end 80b of the reservoir spring 80 disposed on the counter side of the reservoir piston 68. The upper-side first guide member 82 and the lower-side second guide member 84 are vertically connected to each other across the reservoir spring 80. This structure can restrict the elongation of the reservoir spring 80.

The first guide member 82 is constituted of a substantially cylindrical member and includes a flange-shaped first engaging portion 88 formed in the lower-side inner periphery of the substantially cylindrical member. The second guide member 84 includes a disk portion 90 insertable into the plug 78 and multiple struts 92 erected upwardly from the disk portion 90. Each strut 92 includes an outwardly projecting second engaging portion 94 integrally formed in the leading end thereof.

Since the second guide member 84 is fixed (for example, pressure fixed) to the plug 78 through the disk portion 90, even when the reservoir piston 68 moves in a direction to reduce the reservoir chamber 74 and the reservoir piston 68 and the first guide member 82 are thereby disengaged from each other, the first guide member 82, the second guide member 84 and the reservoir spring 80 can stay at their respective positions, thereby preventing these members against unnecessary movements within the reservoir storing hole 62.

Since the first engaging portion 88 and the second engaging portion 94 are engaged with each other in the inner and outer peripheries thereof, the first guide member 82 and the second guide member 84 are connected together to be slidable along the vertical direction. The engagement between the first engaging portion 88 and the second engaging portion 94 can restrict the elongation of the reservoir spring 80 to thereby restrict variations in the height of the reservoir spring 80 with a simple structure. As a result, variations in the height-direction position of the reservoir piston 68 can be restricted. In the first guide member 82 and the second guide member 84, since the first engaging portion 88 and the second engaging portion 94 are formed integrally therewith, there is eliminated the need for provision of special members for restricting the elongation of the reservoir spring 80, whereby the number of parts of the brake control apparatus 16 and thus the manufacturing cost thereof can be reduced.

The first guide member 82 may be formed of metal material and the second guide member 84 may be formed of resin material (see FIG. 2). In the case that the first guide member 82 to be held between the reservoir piston 68 and the reservoir spring 80 and thus to receive a relatively large load is formed of metal material (for example, steel material), the first guide member 82 is enhanced in the rigidity and strength thereof and is thereby harder to deform, whereby pushing force produced when the reservoir piston 68 moves in the reservoir spring 80 compressing direction, or the restoring force of the reservoir spring 80 can be received properly. Also, in the case that the second guide member 84 receiving a relatively smaller load than the first guide member 82 is formed of resin material, the weight of the whole brake control apparatus can be reduced. However, the material of the first guide member 82 and the second guide member 84 is not limited specially but, for example, the first guide member 82 and the second guide member 84 may also be both formed of resin material.

The first engaging portion 88 of the first guide member 82 has a first pawl 96. The second engaging portion of the second guide member 84 has a second pawl 98. One (for example, the second pawl 98 made of resin) of the first pawl 96 and the second pawl 98 is elastically deformed and is snap-fit connected to the other (for example, the first pawl 96 made of metal), whereby the first pawl 96 and the second pawl 98 can be engaged with each other (see FIG. 6B).

The snap-fit connection can facilitate the connection of the first pawl 96 and the second pawl 98, which can reduce the assembling time of the brake control apparatus 16 and thus can enhance the assembling operation efficiency thereof.

The second guide member 84 has multiple second pawls 98 circumferentially arranged at regular intervals (in this embodiment, as shown in FIG. 8B, are arranged at an angular pitch of about 90° along the peripheral direction), while the first guide member 82 has the first pawl 96 formed into a continuous circular belt shape. In the case that the first pawl 96 has a circular belt shape, even when the second guide member 84 rotates about its axis, the engagement thereof with the first guide member 82 can be maintained. Also, since the setting of the assembling direction of the first guide member 82 and the second guide member 84 in the peripheral direction is not necessary (they may be assembled at any arbitrary position in the peripheral direction), the assembling efficiency thereof can be enhanced.

This embodiment employs the structure that, as shown in FIG. 6B, the outwardly projecting second pawls 98 of the second guide member 84 can be engaged with the first pawl 96 formed in the inner peripheral portion of the first guide member 82 in their respective inner and outer peripheral portions. However, contrary to the above structure, there may be employed a structure that the first guide member 82 includes multiple first pawls circumferentially arranged at regular intervals and projected outwardly, and the second guide member 84 includes an annular-shaped second pawl formed in its inner peripheral portion, while these pawls can be engaged with each other in their respective inner and outer peripheral portions.

A C clip 100 is mounted into an enlarged-diameter portion 62a formed in the reservoir storing hole 62 and existing downwardly of the reservoir piston 68 (see FIG. 2). This C clip 100 functions as a stopper (movement amount restricting means) for restricting the downward movement of the reservoir piston 68.

The intermediate valve 73 is constituted of a bottomed cylindrical member and has the resin-made intermediate piston 72 movable along the intermediate valve storing hole 64. The intermediate valve 73 includes, substantially in its central portion, a communication passage 102 for allowing communication between the pump suction chamber 76 existing upwardly thereof and the reservoir chamber 74 existing downwardly thereof. The communication passage 102 includes an opening/closing valve 104 functioning as opening/closing means for opening and closing the communication passage 102. Between the intermediate piston 72 and the suction valve 50, there is interposed an intermediate piston spring 105 for urging the intermediate piston 72 toward the reservoir piston 50. A seal member 75 is mounted through an annular groove onto the outer peripheral surface of the intermediate piston 72.

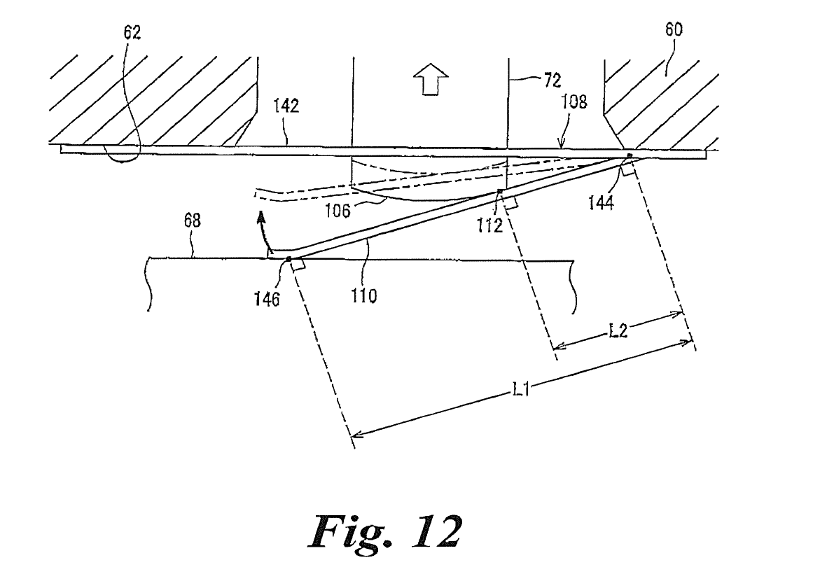

The intermediate piston 72 includes, in its bottom surface, a curved portion 106 formed curved to have an arc-shaped section. This curved portion 106 is contacted with the contact portion 110 of a plate spring member 108 (which is discussed later) to form an intermediate piston contact point 112 (see FIG. 12). The intermediate piston 72 also includes, in its lower portion, a penetration hole 114 of a substantially rectangular section for allowing communication between the reservoir chamber 74 and the communication passage 102.

The opening/closing valve 104 includes a valve seat 116 constituted of a tapered surface formed within a stepped penetration hole formed in the intermediate piston 72, a valve body 118 constituted of a ball (steel ball) capable of sitting on the valve seat 116, and a valve spring 120 for urging the valve body 118 toward the valve seat 116. The valve body 118 and the valve spring 120 are stored within the intermediate piston 72.

A push plate 122 for receiving the spring force of the valve spring 120 is mounted on the axial-direction upper portion of the intermediate piston 72.

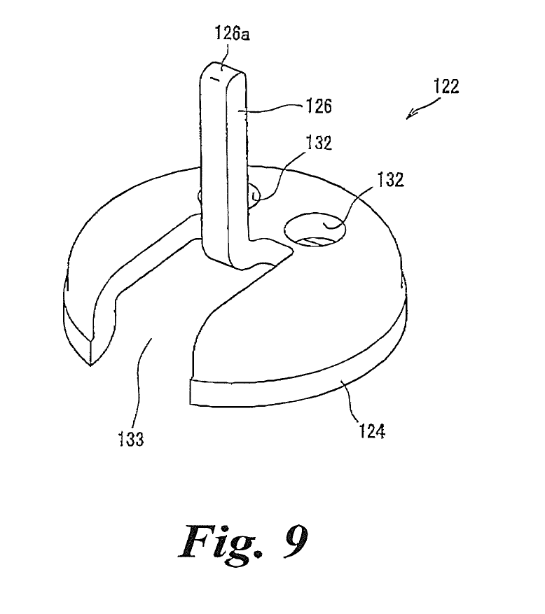

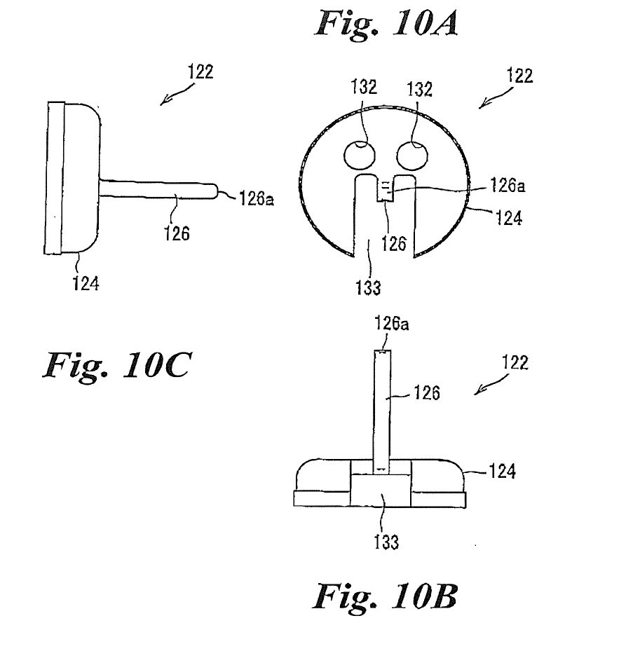

FIG. 9 is a perspective view of the push plate, FIG. 10A is a plan view of the push plate, FIG. 10B is a front view of the push plate, and FIG. 10C is a left side view of the push plate.

This push plate 122 includes, as shown in FIG. 9, a substantially disk-shaped cover portion 124 and an eccentric contact pin 126 constituted of a projection projected upwardly from substantially centrally of the cover portion 124. As shown in FIG. 3, the cover portion 124 is mounted onto the upper portion of the intermediate piston 72, and using the eccentric contact pin 126, a ball 128 (which is discussed later) existing upwardly of the pin 126 is pushed and is separated from its seat portion 130, thereby opening the suction valve 50.

The cover portion 124 includes, as shown in FIG. 9, a pair of circular communication holes 132 and a rectangular cut-out section 133 produced by cutting and raising the eccentric contact pin 126. Formation of the communication holes 132 in addition to the cut-out section 133 can secure the flow of the brake fluid that passes along the communication passage 102 within the opening/closing valve 104.

Integral formation of the push plate 122 including the eccentric contact pin 126 can reduce the number of parts and thus the manufacturing cost thereof. For example, in the case that the cover portion 124 and the eccentric contact pin 126 are integrally formed by press molding, the manufacturing cost of the push plate can be reduced. Also, when the eccentric contact pin 126 is bent worked, by inclining it at a given angle with respect to the normal of the upper surface of the cover portion 124, the leading end of the eccentric contact pin 126 can be eccentrically contacted with the ball 128 (see FIG. 3).

With reference to FIG. 3, the relationship between the eccentric contact pin 126 of the push plate 122 and the ball 128 of the suction valve 50 will be described.

As the reservoir piston 68 and the intermediate piston 72 move upwardly, the eccentric contact pin 126 also rises and comes into contact with the ball 128 of the suction valve 50 (see a broken line in FIG. 3).

The axis X3 of the eccentric contact pin 126 along its longitudinal direction does not exist on the same axis as the center axis X2 of the suction valve 50 nor is parallel thereto but is inclined at a given angle thereto.

That is, the axis X3 of the eccentric contact pin 126 is deviated (offset) from the center axis X2 parallel to the axial direction of the suction valve storing hole 66 functioning as a passage which allows communication between the reservoir 36 and the master cylinder 14 and passes through the center of the ball 128, and the leading end 126a of the eccentric contact pin 126 can be contacted with the ball 128 at a position deviated (offset) from the center axis X2.

Supposing the leading end 126a of the eccentric contact pin 126 is contacted with the center of the ball 128, the movement of the ball could be unstable. However, in the case that the contact position between the leading end 126a of the eccentric contact pin 126 and the ball 128 is set at a position deviated from the center axis X2, the movement of the ball 128 can be stabilized.

Also, the base end 126b (the rising portion branched from the cover portion 124) of the eccentric contact pin 126, which exists on the opposite side to the leading end 126a contactable with the ball 128, is set at a position which does not exist on the same axis as the center axis X2 of the suction valve 50 but is offset by a given distance therefrom.

The given-distance offset position of the base end 126b of the eccentric contact pin 126 from the center axis X2 of the suction valve 50, when the leading end 126a of the eccentric contact pin 126 is contacted with the ball 128, can stop the ball 128 on the opposite side to the offset side, thereby preventing the unstable movement of the ball 128. In order for the longitudinal-direction axis X3 of the eccentric contact pin 126 not to exist on the same axis as the center axis X2 of the suction valve 50, no special working is necessary.

Also, the intermediate piston 72 includes, as shown in FIGS. 2 and 3, a resin-made rod-shaped negative pressure removing pin (negative pressure releasing member) 136. This negative pressure removing pin 136, when the reservoir piston 68 moves by a given amount from its initial position in a direction to reduce the capacity of the reservoir chamber 74, presses the valve body 118 upwardly to separate it from the valve seat 116, thereby opening the opening/closing valve 104.

When the negative pressure state of the reservoir chamber 74 is maintained, there is a fear that the reservoir piston 68 and the intermediate piston 72 can remain attracted. However, since the negative pressure of the reservoir chamber 74 can be removed by using the negative pressure removing pin 136, the reservoir piston 68 and the intermediate piston 72 can be returned to their initial positions, thereby eliminating, for example, a trouble that the space of the reservoir chamber 74 cannot be secured in the ABS control operation.

As shown in FIG. 3, the negative pressure removing pin 136 includes, in its axial-direction intermediate portion, an annular stepped portion 138 engageable into the penetration hole of the intermediate piston 72. The engagement of the annular stepped portion 138 into the penetration hole of the intermediate piston 72 can prevent the pin 136 against removal. A portion of the lower side of the negative pressure removing pin 136 is formed such that it can be exposed from the penetration hole toward the reservoir piston 68. Also, the head portion (upper end) of the negative pressure removing pin 136 is normally not in contact with the valve body 118 through a clearance between them.

As shown in FIG. 2, the moving-direction center axis X2 of the intermediate piston 72 and the moving-direction center axis X1 of the reservoir piston 68 are set as different axes which are substantially parallel to each other and are offset by a given distance from each other. Due to this different-axes structure, the intermediate piston 72 and the suction valve 50 can be disposed such that they are offset, for example, with respect to the position of the reservoir 36, in the diameter direction from the moving-direction center axis of the reservoir piston 68, whereby the lay-out performance of the inside of the base body 60 can be enhanced. Specifically, since the intermediate valve 73 and the suction valve 50 are disposed offset in the radial direction from the moving-direction center axis of the reservoir piston 68, the pump 46 can be disposed in the vertically upward direction of the reservoir piston 68 without interfering with the intermediate valve 73 and the suction valve 50.

In this embodiment, as shown in FIG. 2, there is shown the example in which the moving-direction center axis X2 of the intermediate piston 72 and the center axis X2 of the suction valve 50 are present on the same axis. However, they may also be different from each other.

A C clip 140 is mounted on an enlarged-diameter portion 64a which is formed inside the intermediate valve storing hole 64 and exists downwardly of the intermediate piston 72. This C clip 140 functions as a stopper (moving amount restricting means) for restricting the movement of the intermediate piston 72 toward the reservoir piston 68 (preventing the removal of the piston 72).

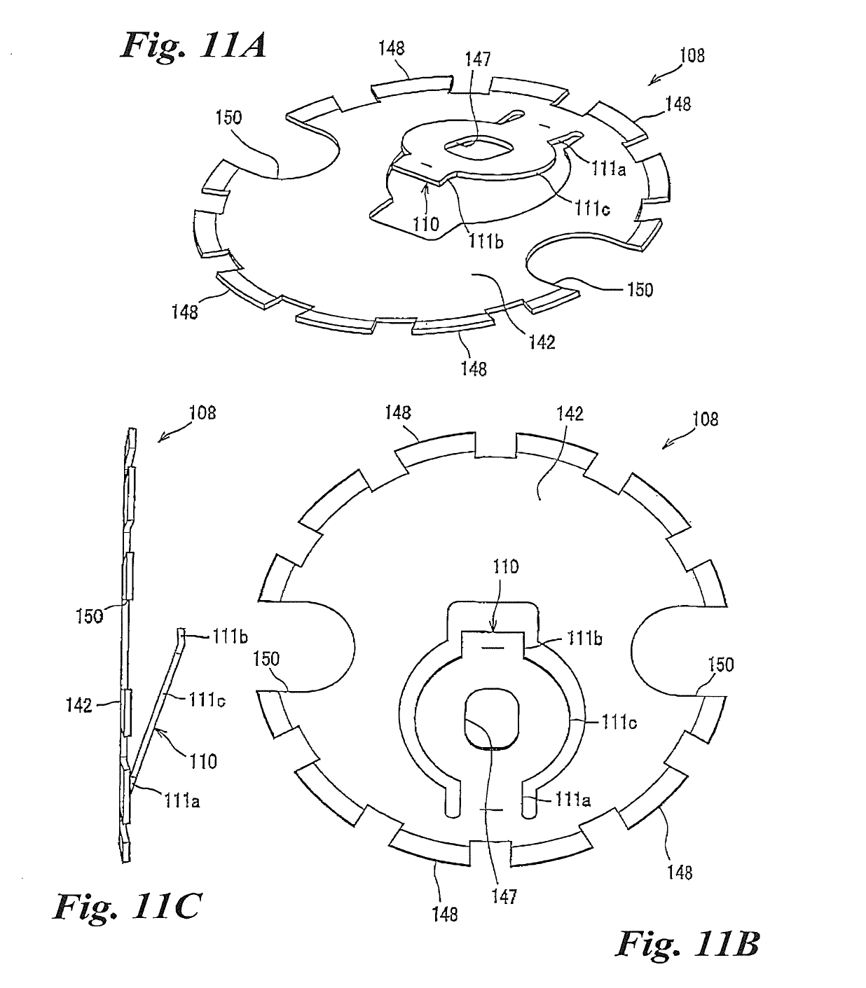

FIG. 11A is a perspective view of the plate spring member, FIG. 11B is a plan view thereof, FIG. 11C is a side view thereof, and FIG. 12 is an explanatory view of the operation thereof, showing the principle of leverage.

Between the reservoir piston 68 and the intermediate piston 72, there is interposed the plate spring member 108. The plate spring member 108 includes a substantially circular flat plate portion 142 and a substantially O-shaped contact portion 110 formed integrally with each other. The contact portion 110 is formed by blanking it from the flat plate portion 142, is inclined at a given angle and can be deformed elastically. The base-end side short band section 111a of the contact portion 110 is formed continuously with the outer edge portion of the flat plate portion 142, while the leading-end side short band section 111b thereof is situated substantially centrally of the flat plate portion 142.

This plate spring member 108 functions as toggle means which amplifies the thrust of the reservoir piston 68 moving toward the intermediate piston 72 and transmits it to the intermediate piston 72. In this embodiment, since the thrust of the reservoir piston 68 can be amplified and transmitted to the intermediate piston 72, for example, even when the brake fluid pressure applied from the master cylinder 14 side to the suction valve 50 is larger than the thrust of the reservoir piston 68, the suction valve 50 can be opened by the intermediate piston 72 to which the amplified thrust has been transmitted. Thus, the opening of the suction valve 50 can be facilitated. For example, even when brake fluid pressure (master cylinder pressure) produced due to high hitting force is applied to the suction valve 50 from the master cylinder 14 side through the fluid pressure passage 48, the suction valve 50 can be opened easily and positively through the intermediate piston 72 to which the amplified thrust has been transmitted.

By using the plate spring member 108 as the toggle means, after the reservoir piston 68 moves toward the suction valve 50, the reservoir piston 68 can be easily returned to its initial position by the spring force of the plate spring member 108. Also, since the contact portion 110 is formed by combining together the two short band sections 111a and 111b with a substantially circular section 111c between them, it can be structured as a simple shape, for example, a rod-like shape or a plate-like shape. As a result, the working of the contact portion 110 can be facilitated.

The contact portion 110, as shown in FIG. 12, includes a fulcrum 144 contactable with the bottom surface of the reservoir storing hole 62, a reservoir piston contact point 146 contactable with the upper surface of the reservoir piston 68, and an intermediate piston contact point 112 contactable with the curved portion 106 of the intermediate piston 72 between the fulcrum 144 and the reservoir piston contact point 146 to press the intermediate piston 72.

Where the distance from the fulcrum 144 of the plate spring member 108 to the reservoir piston contact point 146 is expressed as L1 and the distance from the fulcrum 144 of the plate spring member 108 to the intermediate piston contact point 112 is expressed as L2, due to the so-called principle of leverage, the thrust of reservoir piston 68 is amplified at the rate of (L1/L2).

That is, the respective contact points of the contact portion 110 such as the fulcrum 144, the reservoir piston contact point 146 and the intermediate piston contact point 112 are set. Thus, the thrust of the reservoir piston 68 is amplified simply using the so-called principle of leverage in the above manner, and the amplified thrust can be transmitted to the intermediate piston 72.

Also, the contact portion 110, as shown in FIG. 11, includes an elliptical pin insertion hole 147 through which the rod-shaped negative pressure removing pin 136 (see FIG. 3) can be inserted. Due to the formation of this pin insertion hole 147, even when the contact portion 110 of the plate spring member 108 and a portion of the negative pressure removing pin 136 are disposed in such a manner that they overlap with each other, interference (contact) between the contact portion 110 and the negative pressure removing pin 136 can be avoided. This can restrict the moving-direction dimension of the reservoir piston 68 while maintaining the functions of both of them, thereby reducing the size and weight of the whole of the brake control apparatus.

The flat plate portion 142 includes, in the outer periphery thereof, multiple projecting sections 148 bent and inclined toward the reservoir piston 68 and contactable with the wall surface of the reservoir storing hole 62. Since the flat portion 142 is pressed into (pressure inserted into) the reservoir storing hole 62 in such a manner that the multiple projecting portions 148 are contacted with the wall surface of the reservoir storing hole 62, the flat portion 142 can be easily fixed to the reservoir storing hole 62 by push-nut connection.

The push-nut connection of the flat plate portion 142 of the plate spring member 108 to the wall surface of the reservoir storing hole 62 through the multiple projecting portions 148 can positively fix the plate spring member 108 while preventing it against removal from the ceiling surface of the reservoir storing hole 62.

The flat plate portion 142 also includes a pair of cut-out sections 150 which are disposed opposed to each other. Each cut-out section 150 has a substantially semielliptical shape when viewed from above and can prevent the closing of the fluid pressure passage 54 (see FIG. 4) connected in communication to the ceiling surface of the reservoir storing hole 62.

That is, the fluid pressure passage 54 to be connected to the out valve side, as shown in FIG. 4, extends downwardly from the upper position of the reservoir storing hole 62 to connect to the reservoir chamber 74, and opens in the ceiling surface of the reservoir storing hole 62. In the case that the pair of cut-out sections 150 are formed to correspond to the opening position of the fluid pressure passage communicating with the ceiling surface of the reservoir storing hole 62, even when the plate spring member 108 is disposed on the ceiling surface of the reservoir storing hole 62, the brake fluid is allowed to flow through the pair of cut-out sections 150, thereby preventing the blocking of the flow of the brake fluid between the reservoir chamber 74 and the fluid pressure passage 54.

The suction valve 50, as shown in FIG. 3, includes a seat member 152 pressed into the suction valve storing hole 66 and having the seat portion 130 in its upper portion, the ball 128 capable of sitting on the seat portion 130, a suction valve spring 154 for urging the ball 128 toward the seat portion 130, and a resin-made spring receiving member 156 integrally assembled to the seat member 152 for storing therein the ball 128 and the suction valve spring 154. The spring receiving member 156 is structured to allow the brake fluid to flow through the mesh portion 157 of a filter.

Since the suction valve storing hole 66 is communicatingly connected to the master cylinder 14 through the fluid pressure passage 48, when the ball 128 is separated from the seat portion 130 against the spring force of the suction valve spring 154 and the suction valve 50 is thereby opened, the brake fluid pressure (master cylinder pressure) from the master cylinder 14 is allowed to flow into the pump suction chamber 76 or, contrary to this, the brake fluid pressure within the pump suction chamber 76 is allowed to flow out therefrom toward the master cylinder 14.

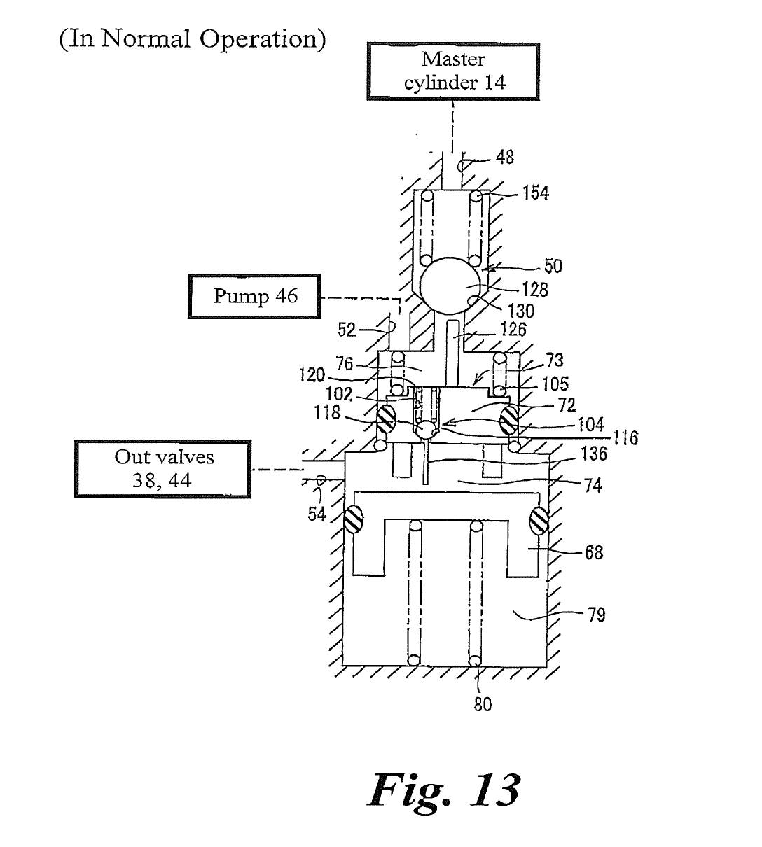

The brake control apparatus 16 according to the embodiment is basically structured in the above manner. Next, referring to FIGS. 13 to 17, the operations and effects of the reservoir 36, the intermediate valve 72 and the suction valve 50 will be described. In the drawings, the structures of the operations and effects of the reservoir 36, the intermediate valve 72 and the suction valve 50 are shown while simplified, and the communication passage 102 is shifted in position.

### <Normal Operation>

Firstly, a normal state is described (see FIG. 13).

In the case that an operator does not step on the brake pedal 12 and thus no brake input is present, the suction valve 50 is kept closed due to the spring force of the suction valve spring 154, with the ball 128 sitting on the seat portion 130. Also, the intermediate valve 73 is pressed toward the reservoir piston 68 due to the spring force of the intermediate piston spring 105 and the eccentric contact pin 126 is separated from the ball 128.

In the normal state, in the case that the brake pedal 12 is stepped by the operator and thus the brake input is present, since the suction valve 50 is kept closed, the master cylinder pressure generated in the master cylinder 14 is blocked by the suction valve 50 and is thereby prevented from flowing toward the reservoir 36.

That is, in this embodiment, the suction valve 50 is constituted of a normally-closed type valve, and in the normal braking operation, the master cylinder 14 and the reservoir chamber 74 are not in communication with each other, thereby preventing the fluid pressure of the master cylinder 14 from acting on the reservoir piston 68. Thus, in this embodiment, the delayed increase of the brake fluid pressure can be restricted, thereby preventing the deteriorated brake feeling.

### <ABS Operation>

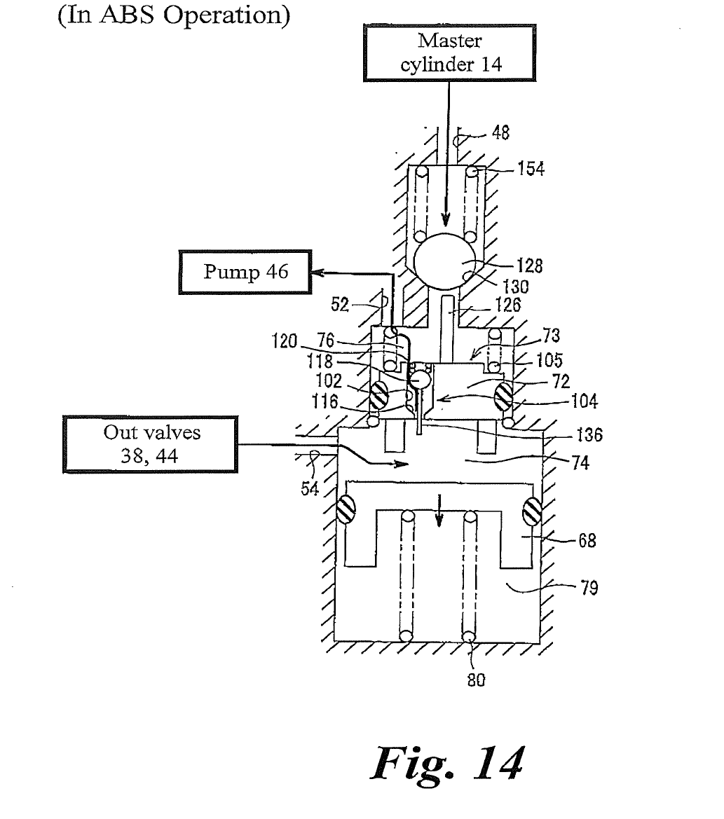

Next, the operation of the ABS control after the brake input is given (FIG. 14) will be described.

Due to the decompression action of the brake fluid (wheel cylinder pressure) -within the respective wheel cylinders W, the brake fluid is allowed to flow into the reservoir chamber 74 through the fluid pressure passage 54. With the flow of the brake fluid into the reservoir chamber 74, the reservoir piston 68 moves in a direction to increase the capacity of the reservoir chamber 74. In this case, since the valve openable pressure of the opening/closing valve 104 provided on the intermediate piston 72 is set low, the valve body 118 separates from the valve seat 116 against the spring force of the valve spring 120, whereby the opening/closing valve 104 is opened quickly.

Therefore, the brake fluid having flown into the reservoir chamber 74 flows into the pump suction chamber 76 through the communication passage 102 of the opening/closing valve 104. The brake fluid having flowed into the opening/closing valve 104 is fed toward the pump 46 through the fluid pressure passage 52. When the valve body 118 opens, no difference is produced between the brake fluid pressure within the pump suction chamber 76 and the brake fluid pressure within the reservoir chamber 74 (between the upstream and downstream sides of the intermediate piston 72) but they are equal or substantially equal to each other, whereby the intermediate piston 72 does not move but is kept to stand still.

As described above, the reservoir piston 68 is moved downward (toward a direction to increase the capacity of the reservoir chamber 74) due to the pressing action of the brake fluid having flowed into the reservoir chamber 74, whereby a given amount of brake fluid can be stored within the reservoir chamber 74. The atmospheric pressure chamber 79 existing below the reservoir piston 68 communicates with the atmosphere through a breathing passage (not shown) and thus has pressure equal to the atmospheric pressure.

Also, since the pump 46 is driven according to a control signal from control means (not shown), the pressure of the upstream side (brake fluid pressure within the reservoir chamber 74) of the intermediate piston 72 and the pressure of the downstream side (brake fluid pressure within the pump suction chamber 76) thereof are substantially equal, or the pressure of the downstream side is lower. Therefore, since the opening/closing valve 104 is normally kept open and the intermediate piston 72 is kept to stand still, the brake fluid stored within the reservoir chamber 74 can be pumped up stably by the pump 46.

### <Pressure Self-Raising Operation>

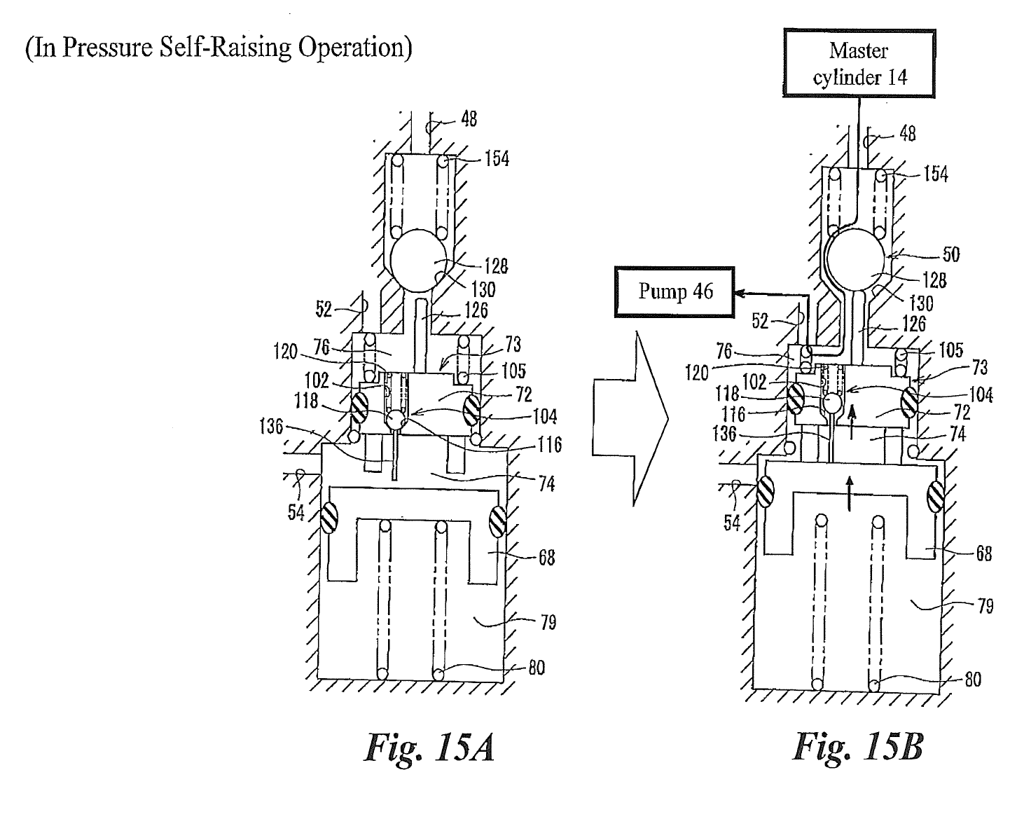

FIG. 15A is a typical view, showing a state a before pressure self-raising operation, and FIG. 15B is a typical view, showing a state of the pressure self-raising operation.

“Pressure self-raising” means a case where the wheel cylinder pressure is raised in order to automatically apply brake force to wheels even when no braking operation by the operator is executed, for example, the vehicle stability assistance and the fraction control.

As shown in FIG. 13, in a state where the suction valve 60 is closed in the normal operation, when the pump 46 is driven according to a control signal from control means (not shown), the pump suction chamber 76 becomes negative in pressure through the fluid pressure passage 52. Simultaneously, the valve body 118 of the opening/closing valve 104 provided on the intermediate piston 72 is also attracted and is thereby separated from the valve seat 116 (see FIG. 3), thereby opening the opening/closing valve 104. As a result, the brake fluid within the reservoir chamber 74 is sucked through the communication passage 102, whereby the reservoir chamber 74 also becomes negative in pressure.

In this case, since the pressure of the reservoir chamber 74 is negative and the pressure of the atmospheric pressure chamber 79 is the atmospheric pressure, there is generated a difference between these pressures, and due to this pressure difference, the reservoir piston 68 is caused to move (rise) toward the intermediate piston 72 (upwardly). In linking with this movement of the reservoir piston 68, the intermediate piston 72 also moves, whereby the leading end 126a of the eccentric contact pin 126 provided on the intermediate piston 72 is contacted with the ball 128 of the suction valve 50 at a position eccentric to the center thereof. Since the ball 128 is pressed by the eccentric contact pin 126 and is thereby separated from the seat portion 130, the suction valve 50 is opened. Consequently, the brake fluid from the master cylinder 14 flows into the pump suction chamber 76 and is then fed toward the pump 46 (see a thick arrow shown in FIG. 15B). The brake fluid fed toward the pump 46 is supplied through the first in valve 32 and/or the second in valve 40 to the respective wheel cylinders W of the disk brake, thereby raising the pressures of the respective wheel cylinders.

In the initial stage of the pressure self-raising operation (before the suction valve 50 is opened), since the brake fluid within the pump suction chamber 76 is supplied to the pump 46, pressure raising by the pump 46 can be carried out quickly. That is, since the intermediate piston 72 moves toward the suction valve 50, the capacity of the pump suction chamber 76 is reduced when compared with the normal operation. Since the capacity of the pump suction chamber 76 is reduced, the pump 46 can effectively carry out the suction action of the brake fluid within the pump suction chamber 76. Especially, when the viscosity (viscous property) of the brake fluid (brake fluid) in the low temperature becomes high, the suction action of the brake fluid can be carried out more effectively.

### <After End of Brake Control>

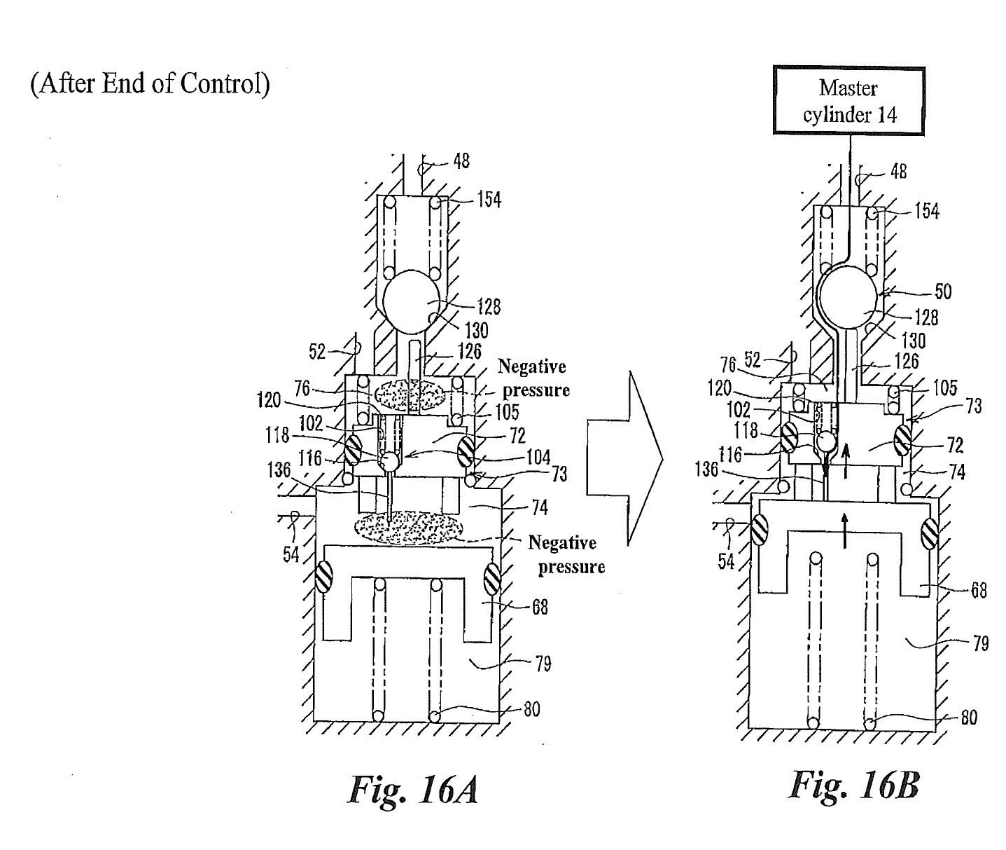

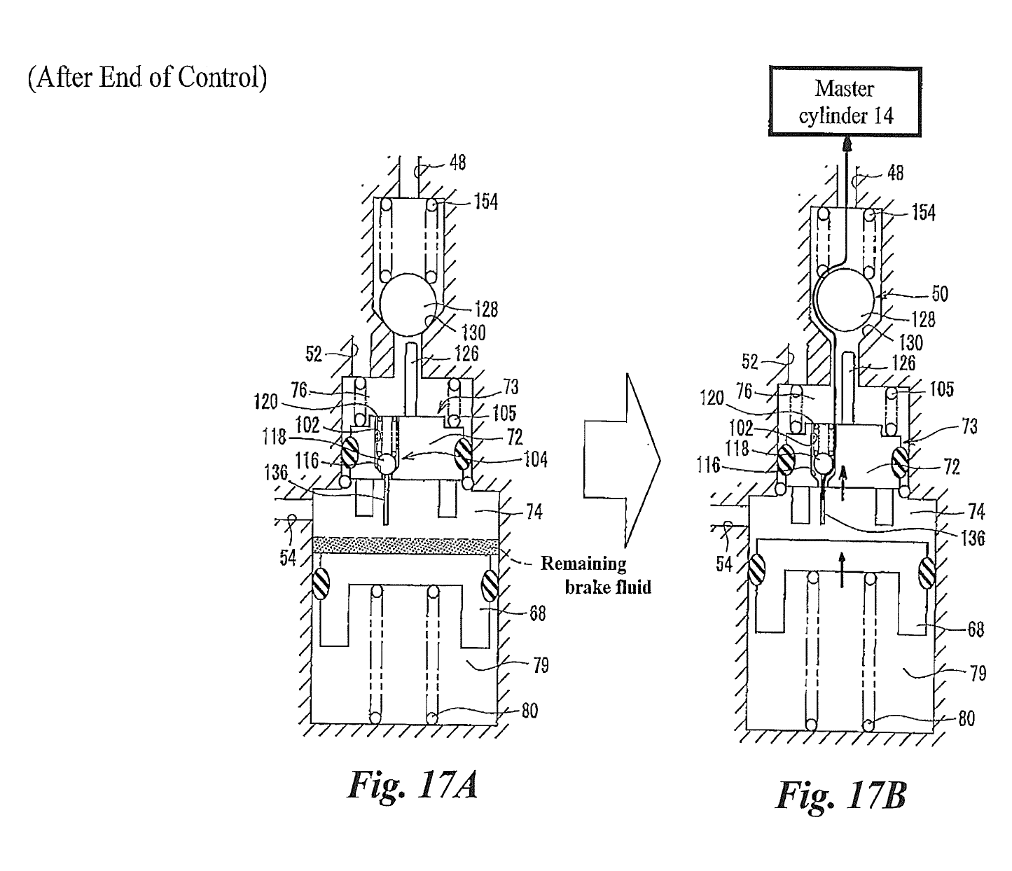

FIG. 16A is a typical view, showing a state where the pump suction chamber and the reservoir chamber are negative in pressure after the end of the brake control, and FIG. 16B is a typical view, showing a state where the suction valve is opened and the above negative states are thereby removed. FIG. 17A is a typical view, showing a state where the brake fluid remains within the reservoir chamber after the end of the brake control, and FIG. 17B is a typical view, showing a state where the suction valve is opened and the remaining brake fluid is thereby returned toward the master cylinder. “After the end of the brake control” means a case where no brake input is given after the end of the brake control and the first out valve 38 and the second out valve 44 each of a normally-closed type are closed.

Whether the brake control is in operation or after it is ended, when the pump suction chamber 76 and the reservoir chamber 74 are negative in pressure (see FIG. 16A), the intermediate piston 72 and the reservoir piston 68 rise in linking with each other and the suction valve 50 is opened, whereby the brake fluid existing on the master cylinder 14 side is allowed to flow through the suction valve 50 into the pump suction chamber 76 and the reservoir chamber 74 (see a thick arrow shown in FIG. 16B), thereby removing the negative pressure state thereof (see FIG. 16B). With removal of the negative pressure state, due to the spring force of the intermediate piston spring 105, the intermediate piston 72 and the reservoir piston 68 are caused to lower in linking with each other, whereby the suction valve 50 is closed.

Thus, when the pump suction chamber 76 and the reservoir chamber 74 are negative in pressure at the end of the brake fluid control, the suction valve 50 is opened to remove the negative pressure states of these chambers, and after then, these chambers can be returned to their initial states shown in FIG. 13. As a result, when the pump suction chamber 76 and the reservoir chamber 74 are returned to the initial states, they can be positively prevented from being maintained in the negative pressure states.

Also, in the case of control having a decompressing operation like the ABS control, conventionally, the drive time of the pump 46 (motor M) is set so as to sufficiently prevent the brake fluid from remaining within the reservoir chamber 74 after the end of the control (to prevent the reservoir piston 68 from being left moved in the direction to increase the capacity of the reservoir chamber 74). Conventionally, since the drive time of the pump 46 and the motor M after the end of the control is longer by such amount, in some cases, the drive sounds of the pump 46 and the motor M can be felt harsh.

In this embodiment, by opening the suction valve 50 at the end of the control, the brake fluid remaining within the reservoir chamber 74 (see FIG. 17A) can be returned toward the master cylinder 14 (see a thick arrow shown in FIG. 17B).

That is, the reservoir spring 80 for urging the reservoir chamber 74 in a direction to reduce the capacity thereof is flexed (see FIG. 17A) by the brake fluid remaining within the reservoir chamber 74, and this reservoir spring 80 generates a spring force (restoring force) to return it to the initial position thereof. Such spring force of the reservoir spring 80 increases the pressure of the inside of the reservoir chamber 74 to generate a pressure difference between the reservoir chamber 74 and the pump suction chamber 76. This pressure difference opens the valve body 118 of the opening/closing valve 104. The intermediate piston 72 is held in the state of the initial position of FIG. 17A, whereas only the valve body 118 of the opening/closing valve 104 is separated from the valve seat 116 and is thereby opened.

Such opened state of the valve body 118 of the opening/closing valve 104 causes the remaining brake fluid to flow into the pump suction chamber 76, thereby increasing the pressure thereof. Further, due to the pressure difference between the pump suction chamber 76 and the fluid pressure passage 48 on the master cylinder 14 side, the ball 128 is separated from the seat portion 130 to open the suction valve 50. Therefore, the brake fluid (remaining brake fluid) having flowed into the pump suction chamber 76 can be returned toward the master cylinder 14.

Thus, in this embodiment, it is not necessary to pay attention to the amount of the brake fluid remaining within the reservoir chamber 74 after end of control, nor it is necessary to set the drive time of the pump 46 (motor M) for a long time, thereby enhancing the quiet property of the brake control apparatus.

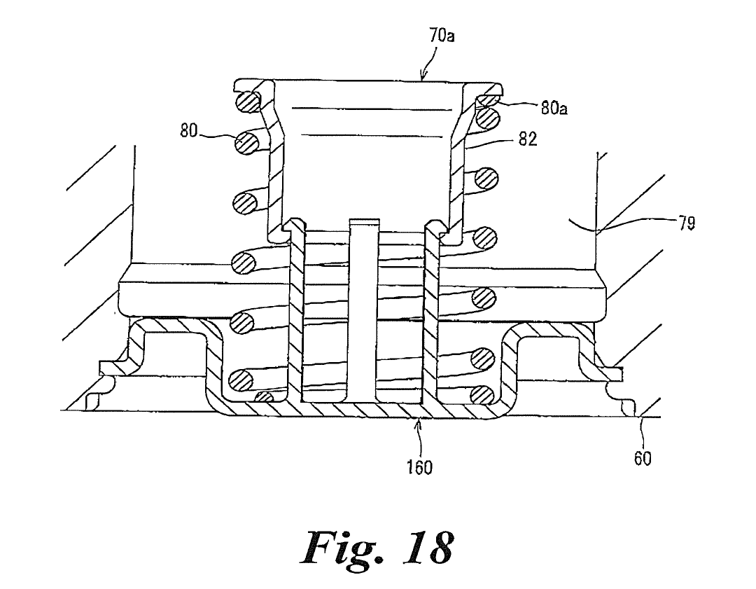

FIG. 18 is a partially cut-out perspective view of a guide mechanism according to another embodiment.

A guide mechanism 70a according this embodiment is different from the above embodiment in that it includes a member 160 in which the plug 78 for closing the opening 61 of the base body 60 and the lower-side second guide member 84 are formed integrally.

With this structure, the number of parts can be reduced and thus the manufacturing cost can be reduced.

As still another embodiment, the reservoir piston 68 and the upper-side first guide member 82 may be formed integrally. With this structure, also, the number of parts can be reduced and thus the manufacturing cost can be reduced,

1. A vehicle brake fluid pressure control apparatus, comprising:
a base body having a reservoir storing hole;
a reservoir piston stored within the reservoir storing hole, the reservoir piston and the reservoir storing hole defining a reservoir chamber therebetween;
a reservoir spring which urges the reservoir piston at one end thereof in a direction to reduce a capacity of the reservoir chamber;
a first guide member disposed to contact with the one end of the reservoir spring; and
a second guide member disposed to contact with the other end of the reservoir spring,
wherein the first guide member and the second guide member are disposed across the reservoir spring,
wherein the first guide member includes a first engaging portion, and
wherein the second guide member includes a second engaging portion, the second engaging portion being engageable with the first engaging portion from inside or outside.

2. The apparatus of claim 1,
wherein the first engaging portion includes a first pawl,
wherein the second engaging portion includes a second pawl, and
wherein the first pawl and the second pawl are engaged with each other through a snap-fit.

3. The apparatus of claim 1, further comprising:
a plug disposed to seal the reservoir storing hole, the plug being disposed opposite to the reservoir piston across the reservoir spring to thereby support a reacting force of the reservoir spring, and
wherein the second guide member is fixed to the plug.

4. The apparatus of claim 1, further comprising:
a plug disposed to seal the reservoir storing hole, the plug being disposed opposite to the reservoir piston across the reservoir spring to thereby support a reacting force of the reservoir spring, and
wherein the second guide member is formed integrally with the plug.

5. The apparatus of claim 1,
wherein the first guide member is made of metal material.

6. The apparatus of claim 2,
wherein one of the first and second pawls is formed as multiple pawls circumferentially arranged at regular intervals, and
wherein the other of the first and second pawls is formed to have a continuous circular band shape.

7. The apparatus of claim 1,
wherein the first guide member is disposed to contact the reservoir piston.

8. The apparatus of claim 1,
wherein the first guide member is formed integrally with the reservoir piston.
